(19) United States
(12) Patent Application Publication
(10) Pub. No.: US 2015/0084953 A1
(43) Pub. Date: Mar. 26, 2015

(54) METHOD AND APPARATUS FOR ESTIMATING ERROR METRICS FOR MULTI-COMPONENT 3D MODELS

(71) Applicant: THOMSON LICENSING, Issy de Moulineaux (FR)

(72) Inventors: Tao Luo, Beijing (CN); Wenfei Jiang, Beijing (CN); Kangying Cai, Beijing (CN)

(21) Appl. No.: 14/388,885

(22) PCT Filed: Dec. 29, 2012
(86) PCT No.: PCT/CN2012/087936

§ 371 Date: Sep. 29, 2014

(30) Foreign Application Priority Data
Apr. 19, 2012 (CN) PCT/CN2012/074370

(51) Int. Cl. G06T 17/00; G06K 9/62

(52) U.S. Cl. CPC G06T 17/00; G06K 9/6202
USPC 345/420

(57) ABSTRACT

To calculate an error metric between two 3D multi-components models, the facets of 3D components of the first 3D model are uniformly sampled. Between each sampling point in the first 3D model and the surface of the second 3D model, a point-to-surface error is calculated. The point-to-surface errors are then processed to generate the error metric between the first and second 3D models. To speed up computation, the second 3D model can be partitioned into cells, and only the closet cell to a particular sampling point in the first 3D model is used to calculate the point-to-surface error, when computing error or metrics for individual 3D components in the 3D models, the same uniform sampling and cell partition are employed. Consequently, the error of the whole 3D model is substantially a weighted average of the errors computed for the individual components.

### RELATED APPLICATION

This application claims the benefit of International Patent Application No. PCT/CN2012/074370 filed Apr. 19, 2012, which is hereby incorporated by reference.

### TECHNICAL FIELD

This invention relates to a method and apparatus for estimating an error metric for 3D models.

### to BACKGROUND

In practical applications, many 3D models consist of a large number of components. These multi-component 3D models usually contain many repetitive structures in various transformations, as shown in FIG. 1.

Compression algorithms for multi-component 3D models that take advantage of repetitive structures in input models are known. Repetitive structures of a 3D model are discovered in various positions, orientations, and scaling factors. The 3D model is then organized into “pattern-instance” representation. A pattern is used to denote a representative geometry of the corresponding repetitive structure. Components belonging to a repetitive structure are denoted as instances of the corresponding pattern and may be represented by a pattern ID and transformation information, for example, reflection, translation, rotation and possible scaling with respect to the pattern. The instance transformation information may be organized into, for example, reflection part, translation part, rotation part, and possible scaling part. There might be some components of 3D models that are not repetitive, which are referred to as unique components.

### SUMMARY

The present principles provide a method for determining an error metric between a first 3D model and a second 3D model, comprising the steps of: accessing the first and second 3D models, wherein the first 3D model includes a first 3D component and at least another 3D component; determining sampling points in facets of the first 3D component and the at least another 3D component in the first 3D model, wherein the sampling points are uniformly distributed in the facets of the first 3D component and the at least another 3D component in the first 3D model; determining a point-to-surface error between each sampling point in the first 3D component in the first 3D model and the surface of a first 3D component in the second 3D model, the first 3D component in the second 3D model corresponding to the first 3D component in the first 3D model; and determining an error metric between the first 3D component in the first 3D model and the first 3D component in the second 3D model in response to the determined point-to-surface errors as described below. The present principles also provide an apparatus for performing these steps.

The present principles also provide a computer readable storage medium having stored thereon instructions for determining an error metric between a first 3D model and a second 3D model, according to the methods described above.

The present principles also provide a method for determining a normal variation between a first 3D model and a second 3D model, comprising the steps of: accessing a plurality of facet pairs from the first 3D model and the second 3D model, wherein each facet pair corresponds to a facet from the first 3D model and a corresponding facet from the second 3D model; determining an inner product of facet normal vectors for each of the plurality of facet pairs; and determining the normal variation between the first 3D model and the second 3D model in response to the inner products as described below. The present principles also provide an apparatus for performing these steps.

The present principles also provide a computer readable storage medium having stored thereon instructions for determining a normal variation between a first 3D model and a second 3D model, according to the methods described above.

### BRIEF DESCRIPTION OF THE DRAWINGS

FIG. 1 shows exemplary 3D models with a large number of components and repetitive structures;

FIG. 2 shows an exemplary encoder of 3D models according to the present principles;

FIG. 3 shows an exemplary decoder of 3D models according to the present principles;

FIG. 4A shows another exemplary 3D model consisting of two 3D components as shown in FIGS. 4B and 4C, respectively;

FIG. 5 is a flow diagram depicting an example for estimating an error metric between two 3D models, in accordance with an embodiment of the present principles;

FIG. 6A, 6B, and 6C are pictorial examples depicting 3D meshes for the apple component, the multi-component 3D model, and the leaf component of FIG. 4, respectively, FIGS. 6D and 6E are pictorial examples depicting a portion of the apple to and leaf components, and FIG. 6F is a pictorial example depicting sampling points and interior triangles of a triangle, in accordance with an embodiment of the present principles;

FIG. 7A is a pictorial example depicting cell partitions of a 3D model, and FIG. 7B is a pictorial example depicting triangles and facets included in a cell, in accordance with an embodiment of the present principles;

FIG. 8 is a flow diagram depicting an example for estimating normal variation between surfaces of two 3D models, in accordance with an embodiment of the present principles; and

FIG. 9 shows an exemplary quality estimator according to the present principles.

### DETAILED DESCRIPTION

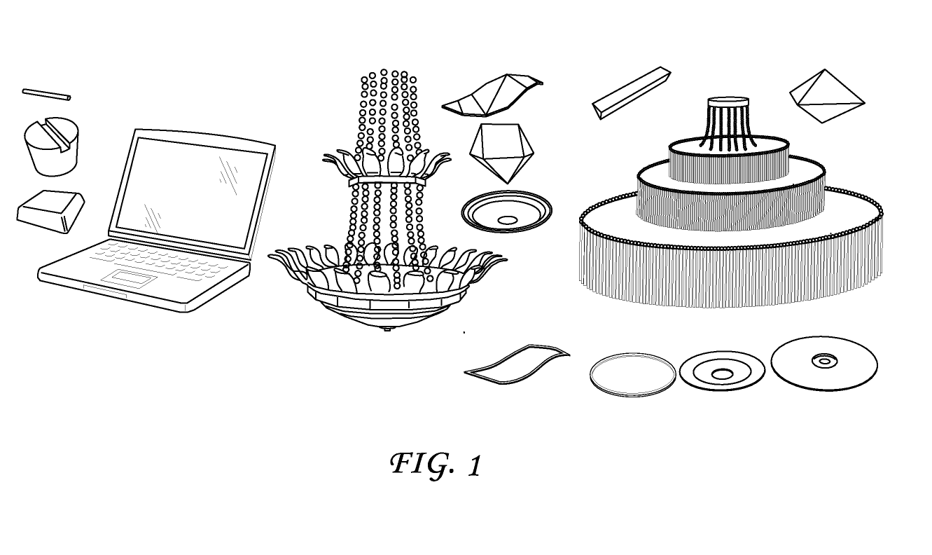

As shown in FIG. 1, there may be many repetitive structures in 3D models. To efficiently encode 3D models, repetitive structures may be organized into patterns and instances, wherein an instance is represented as a transformation of a corresponding pattern, for example, using a pattern ID of the corresponding pattern and a transformation matrix which contains information on translation, rotation, and scaling.

When an instance is represented by a pattern ID and a transformation matrix, the pattern ID and the transformation matrix are to be compressed when compressing the instance. Consequently, an instance may be reconstructed through the pattern ID and the decoded transformation matrix, that is, an instance may be reconstructed as transformation (from the decoded transformation matrix) of a decoded pattern indexed by the pattern ID.

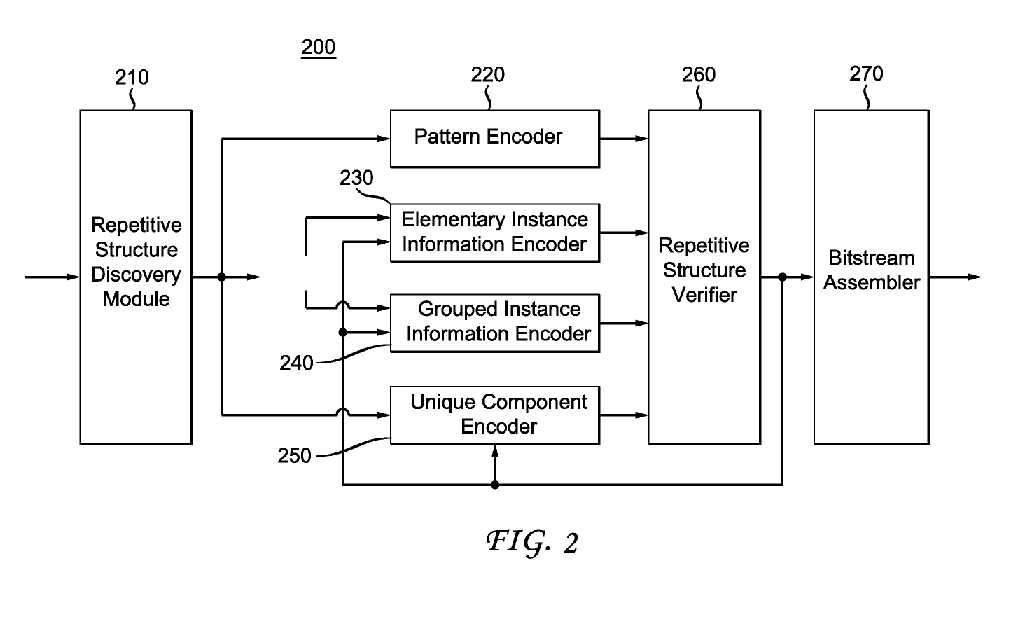

FIG. 2 depicts a block diagram of an exemplary 3D model encoder 200. The input of apparatus 200 may include a 3D model, quality parameter for encoding the 3D model and other metadata. The 3D model first goes through the repetitive structure discovery module 210, which outputs the 3D model in terms of patterns, instances and unique components. A pattern encoder 220 is employed to compress patterns and a unique component encoder 250 is employed to encode unique components. For instances, the instance component information is encoded based on a user-selected mode. If an instance information group mode is selected, the instance information is encoded using grouped instance information encoder 240; otherwise, it is encoded using an elementary instance information encoder 230. The encoded components are further verified in the repetitive structure verifier 260. If an encoded component does not meet its quality requirement, it will be encoded using unique component encoder 250. Bitstreams for patterns, instances, and unique components are assembled at bitstream assembler 270.

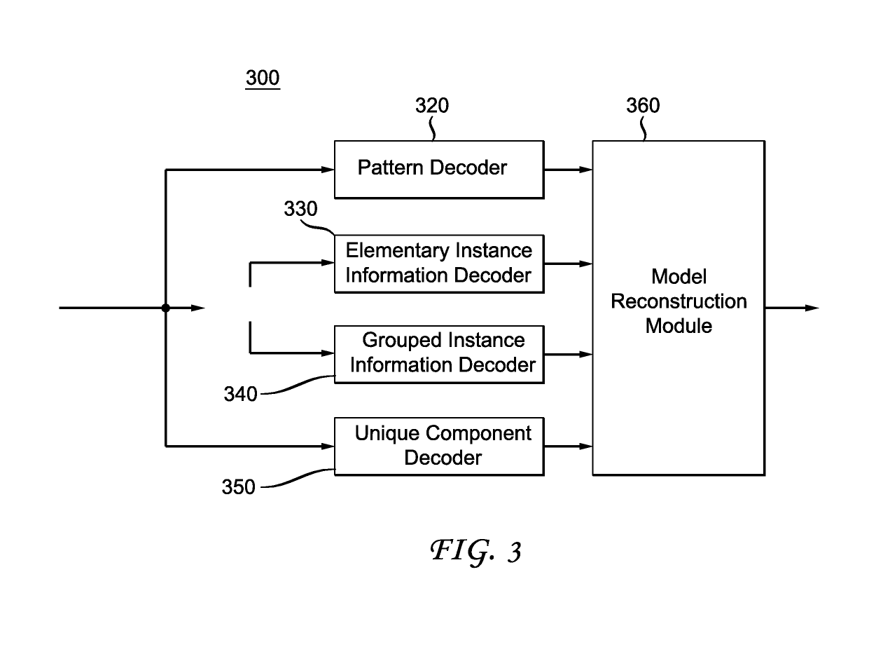

FIG. 3 depicts a block diagram of an exemplary 3D model decoder 300. The input of apparatus 300 may include a bitstream of a 3D model, for example, a bitstream generated by encoder 200. The information related to patterns in the compressed bitstream is decoded by pattern decoder 320. Information related to unique components is decoded by unique component decoder 350. The decoding of the instance information also depends on the user-selected mode. If an instance information group mode is selected, the instance information is decoded using a grouped instance information decoder 340; otherwise, it is decoded using an elementary instance information decoder 330. The decoded patterns, instance information and unique components are used to generate an output decoded 3D model at model reconstruction module 360.

In repetitive structure verifier 260 of the 3D model encoder 200, the error between the original instance component and the reconstructed component is compared. If the error is larger than what is set by quality requirement, the instance would be encoded as a unique component. In this application, both “distance” and “error” may refer to the distortion between two models, and the terms “distance”, “error”, and “distortion” are used interchangeably.

To measure the error between two 3D models, for example, between an original 3D model and a decompressed 3D model, some existing methods adopt a surface sampling approach to measure an error between surfaces. That is, the error between surfaces of two 3D models is computed based on point-to-surface distances for individual sampling points. In these existing approaches, sampling density depends on the size of the bounding box of the 3D model. Consequently, when verifying quality for individual instance components which may vary in sizes of the bounding boxes, the sampling density also varies with individual components.

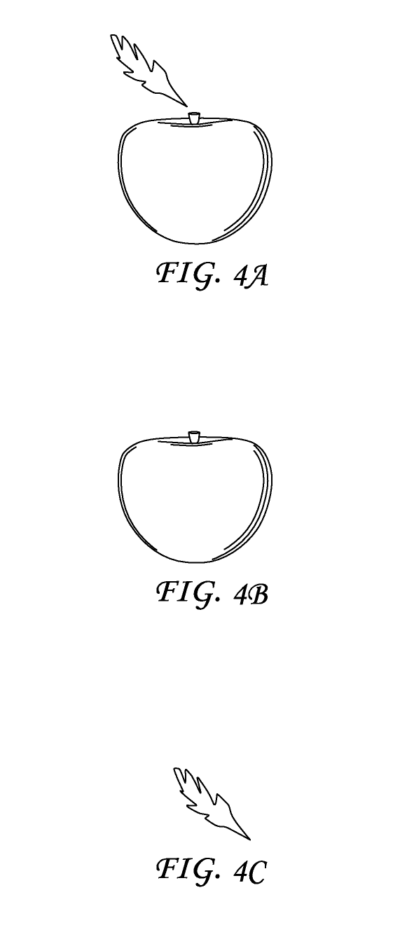

TABLE 1 shows mean errors estimated by MESH, as described in N. Aspert, D. Santa-Cruz, and T. Ebrahimi, “MESH: Measuring errors between surfaces using the Hausdorff distance,” Proceedings of the IEEE International Conference in Multimedia and Expo (ICME), pp. 705-708, 2002, for an exemplary 3D model shown in FIG. 4A. In this example, the apple and the leaf as shown in FIGS. 4B and 4C, respectively, are regarded as two individual 3D components, and the apple and leaf together, as shown in FIG. 4A, is regarded as a multi-component 3D model. After the 3D model is compressed, the error between surfaces of the original 3D model and the decompressed 3D model is measured.

The distance between two sampling points may be determined based on sampling density, for example, the sampling distance may be calculated as a product of sampling density and the diagonal length of a bounding box. Depending on the sampling density, the errors measured for the apple, the leaf, and the apple and leaf vary significantly. Thus, if the components have different sampling density, the errors may not be comparable, and thus may not properly reflect the actual errors.

TABLE 1

| Sampling | apple/10⁻⁶ | leaf/10⁻⁶ | leaf + apple/10⁻⁶ |
|---|---|---|---|
| density | (area: 0.03214) | (area: 0.00133) | (area: 0.03347) |
| 0.005 | 4.3194 | 1.8393 | 6.0139 |
| 0.05 | 5.9429 | 2.6515 | 7.1439 |
| 0.01 | 4.6839 | 1.7290 | 6.3146 |

As discussed above, in encoder 200, a multi-component 3D model is coded component by component. For each instance component, the quality of the reconstructed component is measured to check whether it can be represented by the pattern-instance mode. To get consistent quality across different components, a quality measure needs to be comparable among individual components and provides a certain connection between the quality of individual components and the entire 3D model. Therefore, we attempt to design an error metric such that the error measure for the entire 3D model should be a weighted sum of errors for individual components.

That is, the present principles provide a metric to estimate the error between two 3D models. In one embodiment, when computing error metrics for the whole 3D model or its individual components, a unified sampling step and cell partition may be employed to estimate errors. Consequently, the error of the whole 3D model can be approximated by a weighted average of the errors computed for its individual components, wherein the weight may depend on the specific definition of errors. For example, the weight can be based on the surface area or the number of sampling points of a 3D component. When flip surfaces (i.e., corresponding surfaces from two 3D models have normals in opposite directions) exist, an additional error metric is defined in terms of the normal vectors.

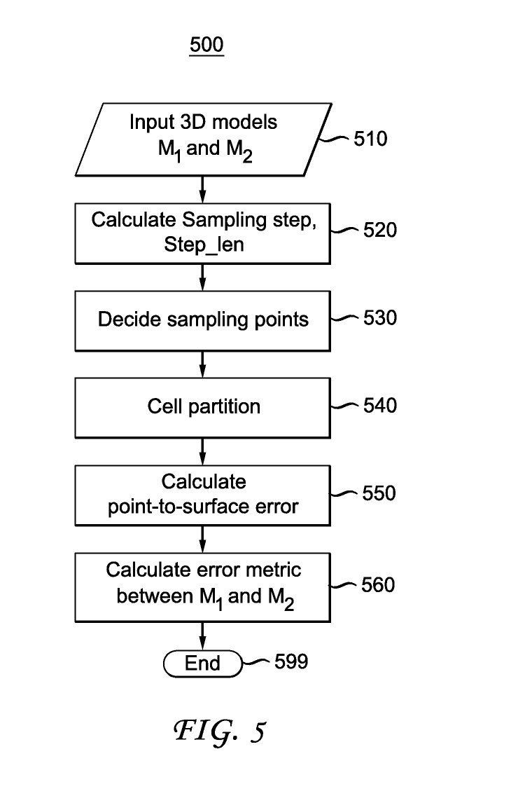

FIG. 5 illustrates an exemplary method 500 for estimating an error metric between two 3D models M₁ and M₂. The distortion can be measured using mean error (ME) or root mean square error (RMSE) of geometric distances. Method 500 starts at step 510, where 3D models (M₁ and M₂) are input. To compute the distance between models M₁ and M₂, a sampling step length (Step_len) is calculated at step 520, and the surface of M₁ is sampled to get a number of sampling points at step 530.

The space of M₂ is divided into cells at step 540, for example, to accelerate the computation. Step 540 may be optional. The distance from an individual sampling point on M₁ to the surface of M₂ is calculated at step 550. An overall error metric between models M₁ and M₂ is calculated at 560. Method 500 ends at step 599.

In the following, the steps of calculating (520) sampling step length, deciding (530) sampling points, cell partitioning (540), and calculating (550) point-to-surface error are described in further detail.

### Sampling

To sample on surface of model M₁, the sampling step length (Step_len) can be defined in terms of the average edge length of model M₁, and can be calculated as:

Step_len=Aver_edge*Sampling_freq, (1)
where Aver_edge is the average edge length of model M₁ and Sampling_freq is a constant, for example, 0.05 in one implementation, which can be used to adjust the sampling density and control the number of sampling points. Aver_edge may also be determined from other sources, for example, input metadata.

Using the sampling step length computed above, the number of sampling points can be determined during the sampling process. For an individual facet (for example, a triangle) on the surface of M₁, the number of sampling points on each side edge can be calculated as:

nₛₚₗ=└\sqrt{0.25+2*Areaᵢ/Step_len²}−0.51┘, (2)
where Areaᵢ is the area of triangle i.

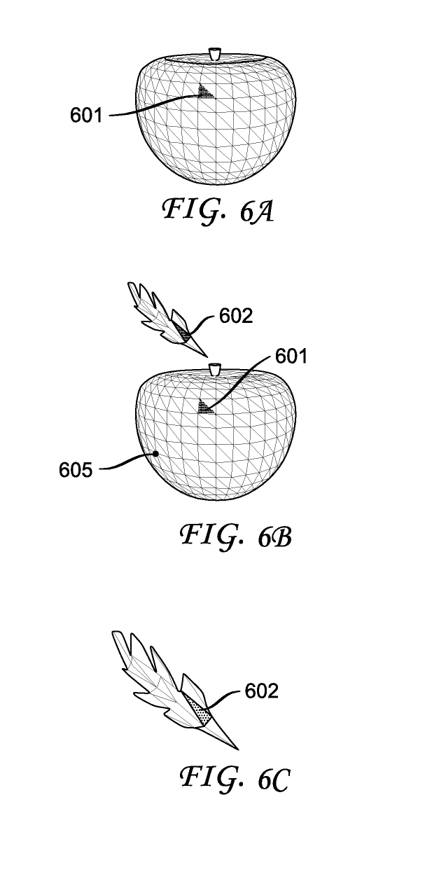

Using the 3D model shown in FIG. 4A as an example, the sampling points are illustrated in FIGS. 6A-6F. FIGS. 6A, 6B, and 6C show 3D meshes for the apple component, the multi-component 3D model, and the leaf component, respectively. For triangle 601 in the apple component and triangle 602 in the leaf component, sampling points and surrounding triangles are illustrated in FIGS. 6D and 6E in a larger scale. Even though triangles 601 and 602 belong to different components, they have substantially the same sampling step length. Consequently, because triangle 602 is bigger than triangle 601, there are more sampling points for triangle 602.

FIG. 6F further shows sampling points for triangle 601. As shown in FIG. 6F, an edge may be uniformly sampled to obtain nₛₚₗ sampling points (for example, points 610, 620, 640, and 670 on the left edge), which results in a total of nₛₚₗ * (nₛₚₗ+1)/2 sampling points in a triangle. In one implementation, if nₛₚₗ<2, nₛₚₗ is set to 2. By associating the number of sampling points with the size of the facet, the sampling points are approximately uniformly distributed in a two-dimensional space. In addition, when there are multiple components in model M₁, the sampling points are uniformly distributed over different components in the 3D model.

### Cell Partition and Point-to-Surface Error Calculation

To calculate a point-to surface error between a sampling point in 3D model M₁ and the surface of another 3D model M₂, a greedy method, which finds the minimum from the errors between one point and all faces, may be used.

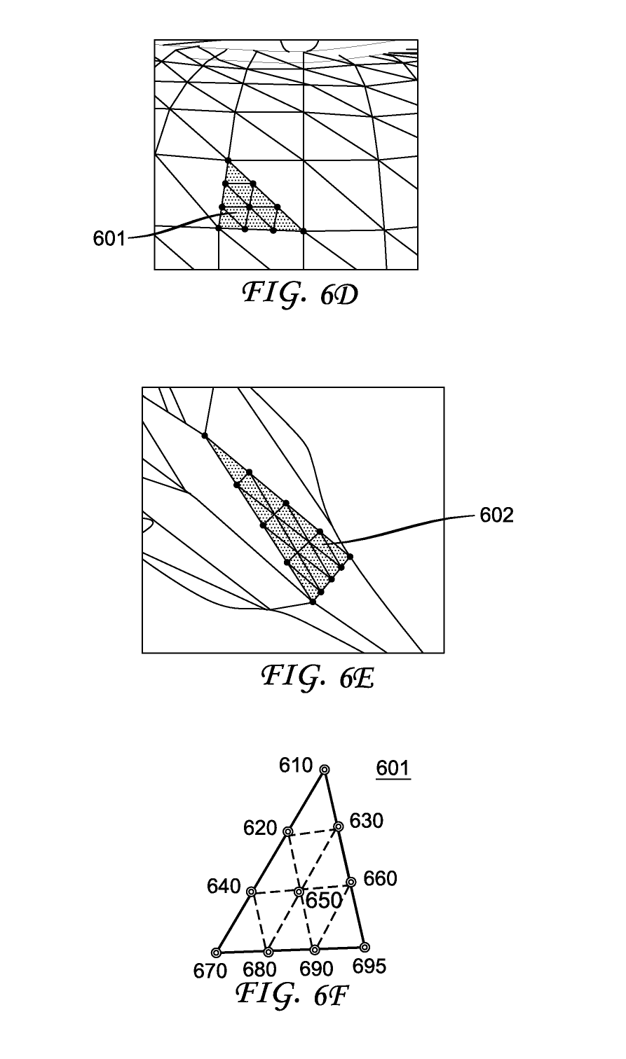

To accelerate computation, the object space of 3D model M₂ can be divided into a number of cells. An individual cell contains a set of triangle facets. For example, as shown in FIG. 7A, model M₂ may be partitioned into cells 710, 720, 730, 740, and other cells. FIG. 7B illustrates vertices and triangles surrounded by cell 710. The side length of each cell cubic may be determined using the average edge length (Aver_len) as follows:

C_sz=Cell_Tri_Ratio*Aver_edge, (3)
where Cell_Tri_Ratio is a constant. Therefore, when there are multiple 3D components in model M₂, the space circumvented by the bounding box of M₂ is divided into cells with the same size for the whole multi-component model and its components.

To quickly compute the distance from a sampling point (for example, point 605) on M₁ to the surface of M₂, the nearest distance from the sampling point to the center of cells is first computed. Once the nearest cell is found, for example, cell 710 in FIG. 7A, the distance between the sampling point and every triangle within cell 710 is calculated, and the nearest distance is used as the point-to-surface error from point 605 on M₁ to surface M₂.

After computing the point-to-surface errors between individual sampling points on model M₁ and the surface of model M₂, the mean error or root mean square error between two 3D models can be calculated accordingly. Using the j^{th} triangle on M₁ for example, which contains nⱼ sampling points on each side edge and whose area is Aⱼ. After uniform sampling, (nⱼ−1)² interior triangles (for example, triangles formed by points {610, 620, 630}, {620, 640, 650},{620, 630, 650}, {630, 650, 660}, {640, 670, 680}, {640, 650, 680}, {650, 680, 690}, {650, 660, 690}, and {660, 690, 695} are interior triangles) are obtained, as shown in FIG. 6F. For an interior triangle i, the point-to-surface errors between its vertices and the surface of model M₂ are denoted as e_{i,k}_{₀}, e_{i,k}_{₁}, e_{i,k}_{₂}, respectively. In an interior triangle i, the mean error then can be computed as:

meᵢ=(e_{i,k}_{₀}+e_{i,k}_{₁}+e_{i,k}_{₂})/3, (4)
and the mean square error can be computed as:

mseᵢ=(e_{i,k}_{₀}*(e_{i,k}_{₀}+e_{i,k}_{₁}+e_{i,k}_{₂})+e_{i,k}_{₁}*(e_{i,k}_{₁}+e_{i,k}_{₂})+e_{i,k}_{₂}*e_{i,k}_{₂})/6. (5)

Subsequently, the mean error between models M₁ and M₂ can be computed as follows:

$$ME = \frac{1}{{\sum }_{j} {A}_{j}} ( {\sum }_{j} \frac{{A}_{j} {\sum }_{i} {me}_{i}}{{( {n}_{j} - 1 )}^{2}} ) . \qquad ( 6 )$$

and the root mean square error can be calculated as:

$$RMSE = \sqrt{\frac{1}{{\sum }_{j} {A}_{j}} ( {\sum }_{j} \frac{{A}_{j} {\sum }_{i} {mse}_{i}}{{( {n}_{j} - 1 )}^{2}} )} . \qquad ( 7 )$$

When the error is measured for individual components within the 3D models, the same uniform sampling is used. For example, when an error metric is measured for the leaf component, the same sampling that is used for measuring the error metric for the multi-component model (apple and leaf model) is used. That is, when measuring the error metric for the leaf component, for triangle 602, the sampling points as shown in FIG. 6E are used again. Thus, in the present embodiments, uniform sampling is used for both the entire 3D model and individual components therein when measuring errors. In addition, the cell partition based on the bounding box of the entire 3D multi-component model is used when measuring errors for the entire 3D model and for individual components. Thus, the partitioned cells are consistent during measuring errors for the multi-component model and its individual components.

Advantageously, using uniform sampling over different 3D components in a multi-component 3D model, the present principles avoid the influence caused by different sampling step lengths, and thus provide a more accurate quality metric. The present principles determines the sampling density based on information of the entire multi-component 3D model. In addition, the cell partition step partitions the bounding box of the multi-component model. By using information of the entire components in both sampling and cell partition steps, the resulting error measurement for the multi-component model is a weighted sum of error measurements for its individual components. This property is very important for our 3D compression scheme, for example, as shown in FIG. 2, for distortion evaluation.

For the 3D model and components shown in FIGS. 4A, 4B, and 4C, we calculate errors between the original and reconstructed ones. Setting Sampling_freq=0.5 in Eq. (1), the mean errors for apple component, leaf component, and the entire model are listed in TABLE 2.

TABLE 2

| apple/10⁻⁶ | leaf/10⁻⁶ | leaf + apple/10⁻⁶ |
|---|---|---|
| (area: 0.03214) | (area: 0.00133) | (area: 0.03347) |
| 5.934 | 3.145 | 5.823 |

Weighting the mean errors of apple component and leaf component by their areas, a weighted sum of mean errors for individual components is calculated as follows:

weighted sum=(0.03214e-6*5.934+0.00133e-6*3.145)/(0.03214+0.00133) =5.823e-6
That is, the mean error of the multi-component model is the same as the weighted sum of the mean errors of individual components.

When the error measurements are calculated independently for individual components in the multi-component 3D model, that is, the sampling density and cell partition for the entire 3D model are determined based on the entire model, and the sampling density and cell partition for the individual components are determined independently based on the corresponding individual models, we observed from experiments that the error measurements did not have the above-mentioned property.

Because of the existence of flip surfaces in some 3D models, it is not always sufficient to measure the difference between surfaces of two 3D models with geometric distances. For example, normal variations can reflect the orientation difference between two surfaces, which can be measured using the average normal variations between corresponding facets.

To determine corresponding facet pairs, the distance from the centroid of a triangle facet f_{1,i} on model M₁ to the surface of model M₂ is computed. The triangle facet f_{2,j} on M₂ with the minimum distance (for example, the two facets that are most similar facets on two models) is the corresponding triangle of facet f_{1,i}.

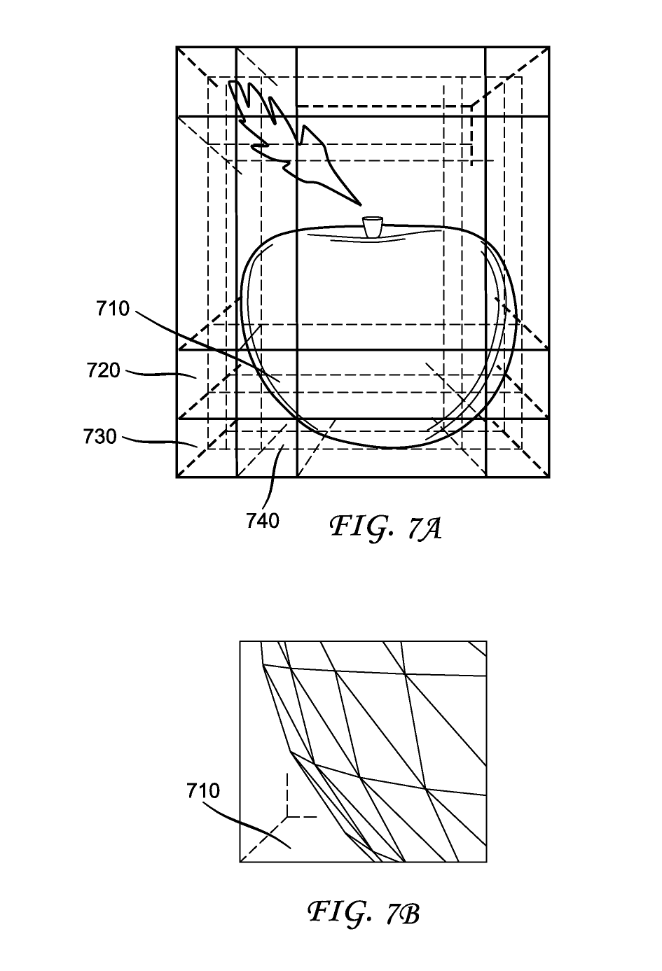

FIG. 8 illustrates an exemplary method 800 for estimating normal variations. At step 810, corresponding facets on model M₂ are found for individual facets on model M₁. The normal variation can be calculated as the average of normal difference between the facet pair (f_{1,i}, f_{2,j}) at step 820. For example, normal variation between corresponding triangle facets (f_{1,i}, f_{2,j}) can be computed as follows:

NErrᵢ=1−(\vec{n_{1,i}}·\vec{n_{2,j}}), (8)
where \vec{n_{1,i}} and \vec{n_{2,j}} denote the face normal vectors of triangles f_{1,i} and f_{2,j} respectively. Consequently, the mean normal variation between surfaces of two 3D models may be computed as follows:

$$MNE = \frac{1}{{\sum }_{i} {A}_{i}} ( {\sum }_{i} {A}_{i} * {NErr}_{i} ) . \qquad ( 9 )$$

Similar to the Hausdorff distance, the proposed error metrics are asymmetric in general, that is Err(M₁, M₂)≠Err(M₂, M₁). The symmetric error can be calculated as the maximum error between these two errors:

Err=max[Err(M₁,M₂),Err(M₂,M₁)], (10)
where Err( ) may be ME, RMSE, MNE defined in Eqs. (6), (7), and (9).

The error metrics can be used to verify whether a reconstructed instance component meets the quality requirement at repetitive structure verifier 260 of the 3D model encoder 200, for example, using an original instance as M₁ and a reconstructed instance as M₂. The error metrics can also be used for rate distortion optimization at the encoder. With the error metrics defined according to the present principles, the performance of compression algorithms may be evaluated fairly for multi-component 3D models. When computing the distances between the reconstructed models and the original ones, the sampling density and division of the object space have been unified for either the whole multi-component object or its individual components. The implementation has also verified the observation that the error for the whole multi-component model is equivalent to the weighted average of the errors for its individual components.

The error metrics may also be used in other applications, for example, to measure similarity in 3D shape retrieval, to define energy functions in 3D model simplification and deformation.

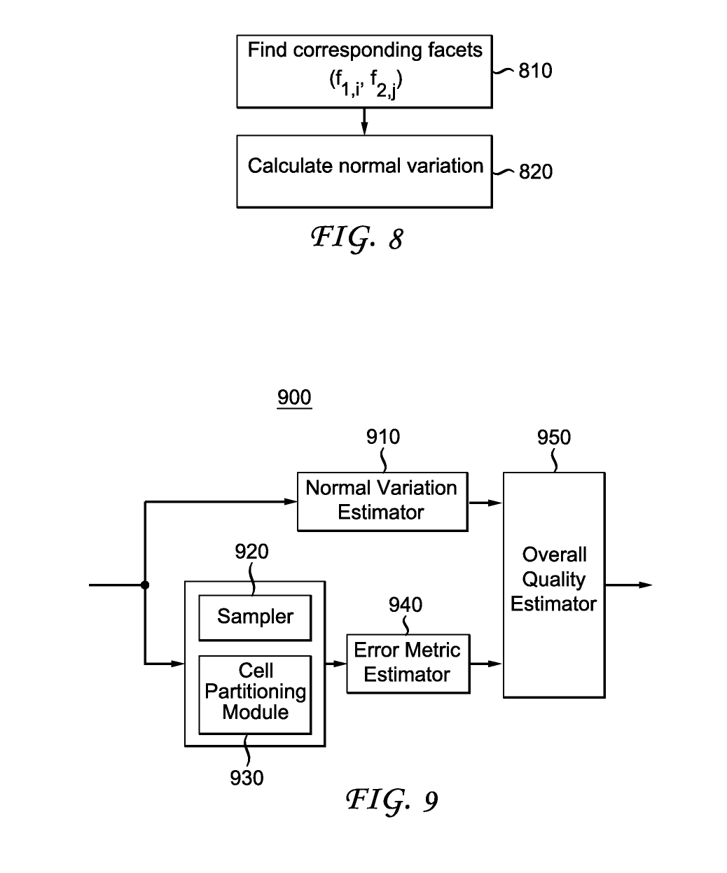

FIG. 9 depicts a block diagram of an exemplary quality estimator 900. The input of apparatus 900 may include a pair of 3D models, for example, an original 3D model and a reconstructed 3D model. Sampler 920 may perform uniform sampling on the surface of a 3D model. Optional cell partitioning module 930 may partition another 3D model into cells. Based on uniform sampling and/or cell partitioning, error metric estimator 940 estimates an error metric between the pair of 3D models, for example, using method 500. On the other hand, normal variation estimator 910 estimates the normal variation between the pair of 3D models, for example, using method 800. The error metric calculated from 940 and the normal variation calculated from 910 may be integrated into an overall quality measure at overall quality estimator 950, or they may be used separately.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for determining an error metric between a first 3D model and a second 3D model, comprising the steps of:
accessing the first and second 3D models, wherein the first 3D model includes a first 3D component and at least another 3D component;
determining sampling points in facets of the first 3D component and the at least another 3D component in the first 3D model, wherein the sampling points are uniformly distributed in the facets of the first 3D component and the at least another 3D component in the first 3D model;
determining a point-to-surface error between each sampling point in the first 3D component in the first 3D model and the surface of a first 3D component in the second 3D model, the first 3D component in the second 3D model corresponding to the first 3D component in the first 3D model; and
determining an error metric between the first 3D component in the first 3D model and the first 3D component in the second 3D model in response to the determined point-to-surface errors.

2. The method of claim 1, further comprising the steps of:
determining a second point-to-surface error between each sampling point in the at least another 3D component in the first 3D model and the surface of at least another 3D component in the second 3D model, the at least another 3D component in the second 3D model corresponding to the at least another 3D component in the first 3D model; and
determining an error metric between the at least another 3D component in the first 3D model and the at least another 3D component in the second 3D model in response to the determined second point-to-surface errors.

3. The method of claim 2, further comprising the steps of:
determining a third point-to-surface error between each sampling point in the first 3D model and the surface of the second 3D model; and
determining the error metric between the first 3D model and the second 3D model in response to the determined third point-to-surface errors, wherein the error metric for the first 3D model corresponds to a weighted sum of the error metric for the first 3D component and the error metric for the at least another 3D component.

4. The method of claim 1, wherein the number of sampling points in the first 3D component in the first 3D model is substantially proportional to a size of the facets of the first 3D component in the first 3D model.

5. The method of claim 1, wherein the sampling points are determined in response to an average length of edges in the first 3D model.

6. The method of claim 1, further comprising, for a particular one sampling point in the first 3D component in the first 3D model:
partitioning the second 3D model into a plurality of cells, which include a set of cells corresponding to the first 3D component in the second 3D model;
determining a cell, from the set of cells, closest to the particular one sampling point;
determining respective distances between the particular one sampling point and respective facets within the closest cell; and
determining a smallest distance of the determined respective distances to be a point-to-surface error between the particular one sampling point and the surface of the first 3D component in the second 3D model.

7. The method of claim 1, further comprising the step of:
performing at least one of rate distortion optimization at an encoder and verifying whether the second 3D model meets a quality requirement.

8. (canceled)

9. An apparatus for determining an error metric between a first 3D model and a second 3D model, comprising:
a processor accessing the first and second 3D models, wherein the first 3D model includes a first 3D component and at least another 3D component;
a sampler determining sampling points in facets of the first 3D component and the at least another 3D component in the first 3D model, wherein the sampling points are uniformly distributed in the facets of the first 3D component and the at least another 3D component in the first 3D model; and
an error metric estimator determining a point-to-surface error between each sampling point in the first 3D component in the first 3D model and the surface of a first 3D component in the second 3D model, the first 3D component in the second 3D model corresponding to the first 3D component in the first 3D model, and determining an error metric between the first 3D component in the first 3D model and the first 3D component in the second 3D model in response to the determined point-to-surface errors.

10. The apparatus of claim 9, wherein the error metric estimator further determines a second point-to-surface error between each sampling point in the at least another 3D component in the first 3D model and the surface of at least another 3D component in the second 3D model, the at least another 3D component in the second 3D model corresponding to the at least another 3D component in the first 3D model, and determines an error metric between the at least another 3D component in the first 3D model and the at least another 3D component in the second 3D model in response to the determined second point-to-surface errors.

11. The apparatus of claim 10, the error metric estimator further determining a third point-to-surface error between each sampling point in the first 3D model and the surface of the second 3D model and determining the error metric between the first 3D model and the second 3D model in response to the determined third point-to-surface errors, wherein the error metric for the first 3D model corresponds to a weighted sum of the error metric for the first 3D component and the error metric for the at least another 3D component.

12. The apparatus of claim 9, wherein the number of sampling points in the first 3D component in the first 3D model is substantially proportional to a size of the facets of the first 3D component in the first 3D model.

13. The apparatus of claim 9, wherein the sampling points are determined in response to an average length of edges in the first 3D model.

14. The apparatus of claim 9, further comprising a cell partitioning module partitioning the second 3D model into a plurality of cells, which include a set of cells corresponding to the first 3D component in the second 3D model, determining a cell, from the set of cells, closest to a particular one sampling point in the first 3D component in the first 3D model, determining respective distances between the particular one sampling point and respective facets within the closest cell, determining a smallest distance of the determined respective distances to be a point-to-surface error between the particular one sampling point and the surface of the first 3D component in the second 3D model.

15. The apparatus of claim 9, further comprising an encoder performing at least one of rate distortion optimization and verifying whether the second 3D model meets a quality requirement.

16-18. (canceled)
